(19) United States
(12) Patent Application Publication
(10) Pub. No.: US 2008/0201474 A1
(43) Pub. Date: Aug. 21, 2008

(54) COMPUTER SYSTEM

(76) Inventor: Yasunori YAMADA, Hadano (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/028,135

(22) Filed: Feb. 8, 2008

(30) Foreign Application Priority Data
Feb. 20, 2007 (JP) 2007-038755

(51) Int. Cl. G06F 15/173

(52) U.S. Cl. 709/226

(57) ABSTRACT

A technique for suppressing the need of active device check by an administrator by providing log data to the administrator for judging whether to replace hardware. A computer system includes: a terminal device in which a user performs direct operation or content check, a plurality of personal computers connected to the terminal device via a network and serving as objects of remote operation by the user, and a storage server device which accumulates information created or referenced by the user, and a start server device having a computer operation managing function which selects a usable personal computer and connects it to the terminal device so as to provide a use environment to the user when the user has made an allocation request to any one of the personal computers via the terminal device.

### BACKGROUND OF THE INVENTION

The present invention relates to a technique of a computer system and in particular, to a technique which can be effectively applied to operation, maintenance, and use of a computer.

The inventor of the present invention has studied about computer system techniques and has found that the following techniques are suggested from the viewpoint of security to prevent loss and leak of electronic information especially from a mobile PC.

(1) A computer operation technique using a so-called “dual client”. That is, instead of connecting a client terminal device directly to a shared server containing an electronic file required for performing a job, the client terminal device is connected to a personal computer for performing the job if a user authentication is successful, and an access is made from the personal computer to a job server and user's data.

(2) A technique for operating a particular computer via a network from a start managing server which manages a start.

(3) A technique for storing a user data region in a storage shared by an organization instead of in a particular personal computer, and performing a linkage to the region containing the data held by a user who has requested for a start when an instruction is received from a start managing server, so as to enable the user to access the user data.

(4) A technique enabling a start of a computer from an image file of a disc in which an operating system and an application are installed, by using a network, and enabling an access to user data without having any storage on a personal computer.

(5) A technique for performing authentication to decide whether a terminal device which outputs a client computer start request is operated by an authorized user when it is operated.

(6) A technique for performing authentication to decide whether a terminal device which operates a client computer is operated by an authorized user when it is operated.

(7) A technique of a client computer start managing server to operate power ON/OFF of the client computer.

The aforementioned techniques are described in documents as follows. JP-A-2002-41348 discloses a technique for sharing a bus by a plurality of electronic computers of high density and bypassing the bus upon failure. JP-A-2007-172359 discloses a technique for providing information to reduce a managing load in a dual client system. JP-A-2005-184350 discloses a technique concerning a method for authenticating a terminal in a configuration for operating a personal computer from a PDA and a mobile telephone. JP-A-2004-192388 discloses a technique which enables a mobile telephone mail to cause a remote computer to execute information processing.

However, the aforementioned computer system techniques have some problems. For example, when using a dual client computer, the management/maintenance job of the personal computer as an operation object of performance and memory should be performed by a system administrator who has conventionally performed only the management of a server device. It is necessary to consider how to reduce the load on the administrator.

### SUMMARY OF THE INVENTION

It is therefore an object of the present invention to provide a technique for suppressing the need of active device check by an administrator by providing log data to the administrator for judging whether hardware is to be replaced.

Other objects and novel features of the present invention will become apparent from the description given below and the attached drawings.

Among the inventions disclosed in the present application, representative ones may be outlined as follows.

The present invention is characterized in that if a group of highly dense personal computers expressed as blade type or cartridge type personal computers cannot be started because of a certain reason, its recovery is automatically tried and its record is automatically provided to an administrator. However, since the operation can technically be performed via a network, the present invention can also be applied to scattered personal computer groups.

In order to realize the aforementioned invention, a computer system comprises: a terminal device in which a user performs direct operation or content check, a plurality of personal computers connected to the terminal device via a network and serving as objects of remote operation by the user, a storage device for accumulating information created or referenced by the user, and a server device which selects a usable personal computer and connects it to the terminal device so as to provide a use environment to the user when the user has made an allocation request to any one of the personal computers via the terminal device. More specifically, the computer system includes means for: (1) personal computer start check, (2) personal computer alive/dead judgment, (3) automatic allocation of an alternative computer, (4) remote ON/OFF of a power source, (5) automatic log acquisition, (6) recovery operating system and application, and (7) means for automatic installation of the recovery operating system and application.

Moreover, when a plenty of personal computers of various types are used from a remote terminal device, it becomes difficult to perform operation with an optimal resource such as a failure and use right presence/absenc, and the TCO becomes higher. These problems are solved as follows.

Firstly, a user is not fixed to each of the personal computers. The user, as a member of a group or an organization to which the user belongs, makes a connection request from a terminal device to a personal computer group appropriate for the performance, the function, and the application appropriate for performing a job of the group or the organization and uses it. From the viewpoint of the administrator side, it is requested to perform such an operation that a plurality of groups or organizations are connected to a plurality of computer groups and a higher-priority use is permitted according to an individual attribute and a time elapse. Here, computer groups to be used with a higher priority by a group to which individuals belong or a member of the group are managed as a table, so that when a use request of a personal computer is received from the terminal device, the start server device automatically searches for an appropriate personal computer by itself. The administrator can perform policy registration of preset how to make the system behave when the start server device has failed in allocation or resources are actually insufficient, so as to semi-automate the operation and reduce TCO.

Among the advantages obtained by the invention disclosed in the present application, the representative one may be briefly outlined as follows.

This invention can reduce the recovery work by a user who is forced to interrupt a job in spite of that no hardware has failed and an administrator. That is, when a personal computer system has failed and the system cannot be started because of a hardware failure or the system is unstable even if it can be started, log data used for judging whether to replace hardware is provided to the administrator. This can suppress the need of active device check by the administrator.

### BRIEF DESCRIPTION OF THE DRAWINGS

FIG. 1 is a block diagram showing an example of configuration of a computer system according to an embodiment of the present invention.

FIG. 2 shows an example of mapping of a logical terminal device and personal computers in the computer system according to the embodiment of the present invention.

FIG. 3 shows an example of managing tables held by a start server device in the computer system according to the embodiment of the present invention.

FIG. 4 is a flowchart showing an example of flow of processes from a connection request from the terminal device made by a user up to a connection of a usable personal computer in the computer system according to the embodiment of the present invention.

FIG. 5 shows an example of the managing tables of FIG. 3 in which actual numeric values are written for the flow of FIG. 4 in the computer system according to the embodiment of the present invention.

FIG. 6 shows an example of a process performed when no available capacity is present in the personal computer which can be used with a higher priority in the computer system according to the embodiment of the present invention.

### DESCRIPTION OF THE EMBODIMENTS

### Outline of an Embodiment

The embodiment of the present invention may be applied to a system including a client system using a combination of a personal computer body in which an operating system and an application operate and a terminal device which remotely operates the personal computer. Moreover, the present invention may be applied to a control system which stores data inherent to a user in a place other than the personal computer or the terminal device so that when a request is made to start the personal computer via the terminal device, a data region inherent to the user is displayed as a virtual drive device or a symbolic link on the personal computer so as to be used by a user.

More specifically, the present invention is applied to a computer system including: a terminal device in which direct operation or content check is performed by a user; a plurality of personal computers which are connected to the terminal device via a network and remotely operated by the user; a storage device which accumulates information created or referenced by the user; and a server device having a computer operation managing function.

Hereinafter, detailed explanation will be given on the embodiment of the present invention with reference to the attached drawings.

(Configuration of Computer System)

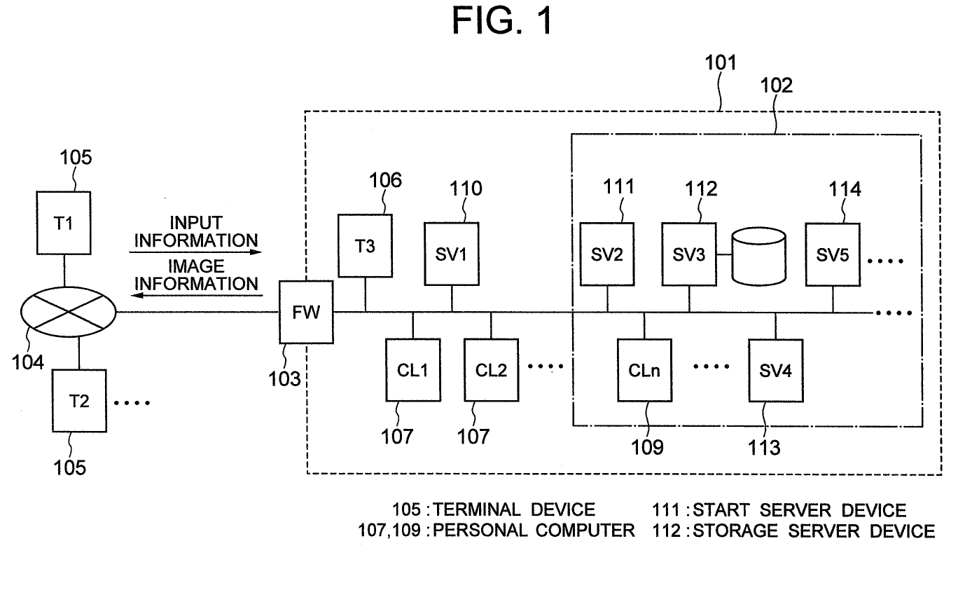

FIG. 1 shows an example of configuration of a computer system according to the embodiment of the present invention, which will be explained below.

The computer system according to the present embodiment includes devices in an organization separated by a boundary line 101, terminals devices (T1, T2) 105 connected to a public network 104 of the general link network, and the like. An intrusion-preventing device called a firewall (FW) is provided at the boundary so as to limit an access to the organization from other than a predetermined port. The terminal device 105 is connected to the public network 104 via a mobile or a remote connection. Via the public network 104, a connection request is issued to start a personal computer in the organization.

On the other hand, a computer room 102 is provided in the organization as an ordinary operation environment so as to physically prevent an intruder. In addition to this, a terminal device (T3), personal computers (CL1, CL2, . . . ) 107, and a job server device (SV1) 110 are arranged outside the computer room 102 in the organization. The present invention may also be applied to use of the personal computers arranged in the organization.

Moreover, inside the computer room 102, a server device group and a personal computer group to be operated from the terminal device which are managed with a higher security. The server device group includes a personal computer start server (SV2) 111 and a storage server device (SV3) 112 for storing user data. Furthermore, the server device group includes job server devices (SV4) 113, (SV5, . . . ) 114 which are conventionally arranged. In the personal computer group, a plurality of personal computers (CLn, . . . ) 109 are arranged.

In the computer system having the aforementioned configuration, the terminal device 105 functions as a terminal device for direct operation or content check by a user. The personal computers 107, 109 function as the personal computers to be remotely operated by the user. The storage server device 112 functions as a storage device which accumulates information created or referenced by the user. The start server device 111 functions as a server device having a computer operation managing function. More specifically, the start server device 111 having the computer operation managing function has following functions.

(1) When a user reports an allocation request to the personal computers 107, 109 via the terminal device 105, a usable personal computer is selected and connected to the terminal device so as to provide a use environment to the user.

(2) When a user makes a request for operation of the personal computers 107, 109 via the terminal device 105, information owned by a user in the storage server device 112 or permitted to be read or modified by a user is allocated to the personal computer in a state enabled for read and modification and a use environment is provided to the user.

(3) According to information requested by a user via the terminal device 105, a personal computer installed with a combination of a particular operating system, an application program, and a version is selected to provide a use environment to the user.

(4) According to information requested by a user, a combination of a particular operating system type or a version and an application software type or a version is selected and then installed on a personal computer to provide a use environment to the user.

(5) A combination of a particular operating system type or a version and an application software type or version which may be requested is accumulated as an image file of the storage device installed in advance, in the storage server device 112 in the system and, upon reception of a use request, the image file is spread on the personal computer to provide a use environment to the user.

(6) In response to a connection request made by a user via the terminal device 105, the personal computer 107 or 109 having a configuration characteristic appropriate for a job content of a user is allocated with a higher priority.

(7) The personal computers 107, 109 may have configuration characteristics defined by a combination of at least one of the following: (a) performance, (b) processor type, (c) type or version of provided operating system, (d) type or version of provided application program, (e) storage device to be connected or position of information in the storage device, (f) storage capacity which can be used, (g) introduction timing, (h) total operation time until the introduction timing, (i) arbitrary classification by administrator, (j) backup device, (k) device for temporary use allocation for guest, (l) operation being prepared/tested, (m) memory size, (n) power consumption per unit time, and (o) network bandwidth size. The combinations are classified as attributes and a personal computer having an appropriate attribute is allocated with a higher priority in response to a connection request made by a user via the terminal device.

(8) According to at least one of the attributes of the personal computers 107, 109, the personal computers are classified into computer groups. At least one of the following items is allocated to all the computers: (a) an identifier (hereinafter, abbreviated as “ID”) as a single article of each personal computer, (b) an ID of the computer group to which a personal computer belongs (including the case when a personal computer belongs to a plurality of computer groups), (c) a current status of a personal computer is “in use”, “not used”, “waiting for maintenance”, “not set”, “allocated as a personal computer not appropriate for a connection request”. Information on a correspondence table between the ID as a single article and the ID as the computer group, a region for storing the status, and an ID information on the user if in use is held, while updating the information to the latest state. A personal computer which is optimal for a new connection request is selected and allocated according to these information.

(9) As a user attribute, at least one of the following items is assigned to all users and held in a local storage device: (a) a unique name or an ID (identifier) for each user, (b) a user group ID of a department or a school lesson class to which the user belongs (including the case when a user belongs to a plurality of groups), (c) a computer group identifier of the personal computer which the user can use with a higher priority (including the case when a change occurs depending on the use period of time and use time band), (d) a priority use level (including the case when a plurality of levels are present), (e) a computer group identifier of a personal computer which can be used with a higher priority according to the priority level (including the case when a plurality of identifiers constitute a pair with the priority use level), (f) time band or period of time of the computer group identifier of the personal computer which can be used according to the priority level (including the case when a plurality of time bands or periods of time constitute a pair with the priority use level) or the case when a change occurs depending on the day of the week or the date), (g) use of the model having no priority use is enabled/disabled, (h) a computer group identifier of the model of the non-priority use, (i) a status region for storing a dynamic state during a use of a personal computer whether an ID of a personal computer and an ID of a computer group to which the personal computer belongs, and the personal computer in use are connected with a higher priority of the user. Upon reception of a request for use of the personal computer made by a user via a terminal device, the attribute of the user, the priority level, and the status of the personal computer are referenced so as to select and start a most appropriate personal computer so that the information owned by the user and the server device group required for the job and connected by the network can be operated from the terminal device, and the stored values are updated to values appropriate for the current state each time the status of all the personal computers and the state of the status regions of all the users are changed.

(10) When a user makes a request for using the personal computers 107, 109 via the terminal device 105 and if all the personal computers matched with the user attribute are in use or no appropriate personal computer exists because of failure or maintenance, at least one of the following processes is executed: (a) an unused personal computer of other computer group having a lower priority for the user is presented to the user so that the user can decide whether to use the unused personal computer, (b) one of the current users who are using the personal computer of a not optimal computer group is terminated with a predetermined rule (the current session is long or short, CPU load is high or low, the user ID arrangement order, personal computer ID arrangement order, etc.) and it is allocated to the user, (c) no connection is made, i.e., the user is made to wait or rejected until the computer group which can be used with a higher priority by the user group of the user who has made the connection request can provide an empty space, (d) a personal computer for a guest or a backup device is allocated.

(11) The user alternation rule is decided by a combination of at least one of the following: (a) the current sessions are disconnected in the descending order of the lengths, (b) the current sessions are disconnected in the ascending order of the lengths, (c) disconnection is performed in the arrangement order of user ID in use in the state that no optimal allocation is performed (both in the ascending order and in the descending order), (d) disconnection is performed in the arrangement order of the personal computer ID not allocated optimally (both in the ascending order and the descending order), (e) disconnection is performed in the descending order of the network load of the personal computers in use, (f) disconnection is performed in the ascending order of the network load of the personal computers in use, (g) disconnection is performed in the descending order of the power consumption of the personal computers in use, (h) disconnection is performed in the ascending order of the specified powers of the personal computers in use.

Description will now be directed to examples of the respective functions of the start server device 111 having the aforementioned computer operation managing functions.

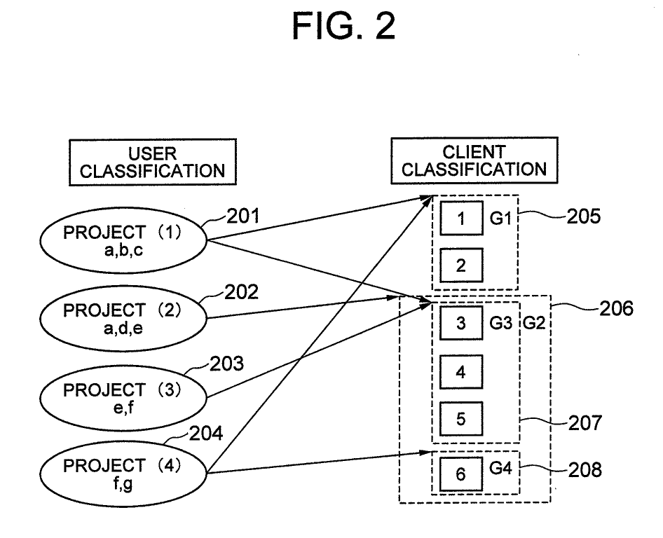

FIG. 2 shows an example of mapping between a logical terminal device and a personal computer in the terminal devices 105, 106 and the personal computers 107, 109 of the computer system according to the present embodiment, which will be detailed below.

Assume that a company has a plurality of projects (1) 201, (2) 202, (3) 203, and (4) 204. Members (a, b, c, d, e, f, g) who are in charge of the projects are classified into groups, which are correlated to personal computer groups (G1) 205, (G2) 206, (G3) 207, (G4) 208 having performances and functions required for the respective projects.

Moreover, a member may participate in a plurality of projects. For example, the member “a” participating in the project (1) 201 also participate in the project (2) 202. Moreover, the member “e” participates in the project (2) 202 and the project (3) 203. The member “f” participates in the project (3) 203 and the project (4) 204. Furthermore, a certain project may set a plurality of personal computer groups for use. For example, for the project (1) 201, the groups (G1) 205 and (G3) 207 are set for use. Moreover, for the project (4), the groups (G1) 205 and (G4) 208 are set for use.

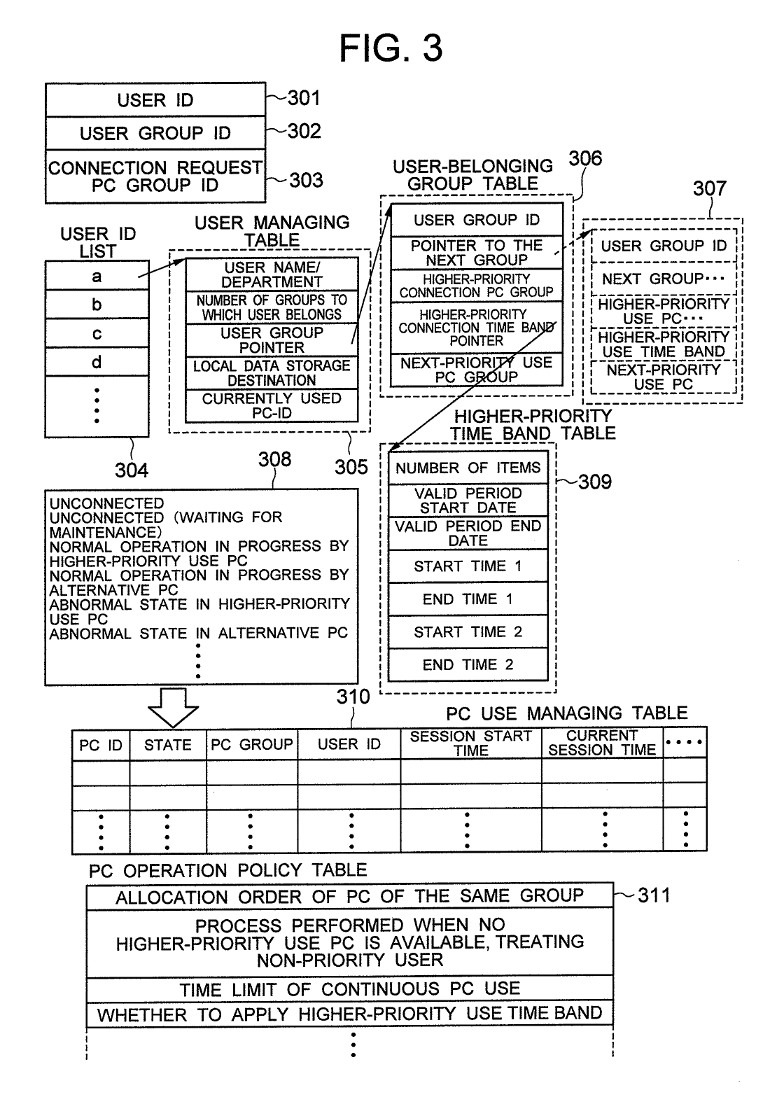

FIG. 3 shows an example of managing tables held by the start server device 111 as tables used to realize the example of FIG. 2. The tables will be detailed below. It should be noted that “PC” in each of the tables indicates a personal computer.

Firstly, the tables of FIG. 3 are logical tables actually stored in a region created in a storage device of the start server device where contents can be dynamically updated.

A user ID 301 and a user group ID 302, and a connection request PC group ID 303 are information received by the start server device from a terminal device of a user.

The managing tables include a user managing table 305, user-belonging group tables 306, 307, a higher-priority time band table 309, a PC use managing table 310, and a PC operation policy table 311, and the like.

The user managing table 305 contains information on a user name/belonging group, a number of belonging groups, a user group pointer, a local data storage destination, and a currently used PC-ID.

The user-belonging group tables 306, 307 contain information on the user group ID, the pointer to the next group, the pointer to the higher-priority connection time band, the PC group of next-priority use.

The higher-priority time band table 309 contains information on the number of items, the valid period start date, the valid period end date, the start time 1, the end time 1, the start time 2, the end time 2, and the like.

The PC use managing table 310 has columns of PCID, the state, the PC group, the user ID, the session start time, the current session time, and the like and contains information corresponding to the respective columns. The state 308 of PC in the PC use managing table 310 may be unconnected, unconnected (waiting for maintenance), normal operation in a PC of higher priority, normal operation in an alternative PC, abnormal state in the PC of a higher priority use, abnormal state in an alternative PC, and the like.

The PC operation policy table 311 contains information on the group PC allocation order, the process performed when no PC of higher priority use is available, handling of a non-priority user, the time limit of continuous PC use, whether a higher-priority use time band is to be applied.

The start server device references the user managing table 305 from the user ID list 304 and references the user-belonging group tables 306, 307 from there so as to identify a user-belong group table which matches with the received user group ID 302. If the higher-priority connection PC group column in the user-belonging table indicates that the PC for the group held by the start server device itself is available, the individual data on the user in the storage device is allocated so as to make a connection with the terminal device of the user. Here, the state 308 of the PC in the PC use managing table 310 is updated and the ID of the currently used PC in the user managing table 305 is recorded so that a terminal device which will make a connection request later can judge whether PC is already used.

If no PC is available in the higher-priority connection PC group, one of the following methods may be selected: (a) a method for searching for a PC which belongs to a PC group of the next-priority use, (b) a method which reports that a current connection is disabled to the user who has made the request, (c) a method which selects one of the users of non-priority use, prompts the user to perform log-out (by waiting for a certain time and then performing forced termination) and then connects the terminal device of the user having a higher priority, and the like. The way how to set these selection branches is based on the content set as a policy in the PC operation policy table 311 by an administrator. The operation policy table 311 is a table defined in advance by the administrator and contains elements for deciding the algorithm associated with the terminal device allocation to users.

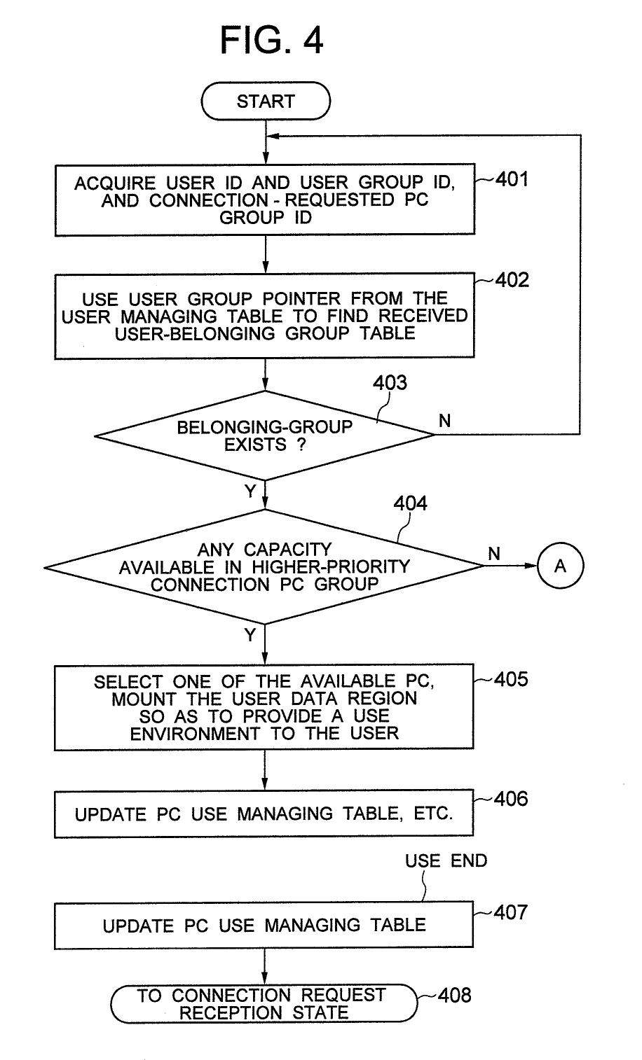

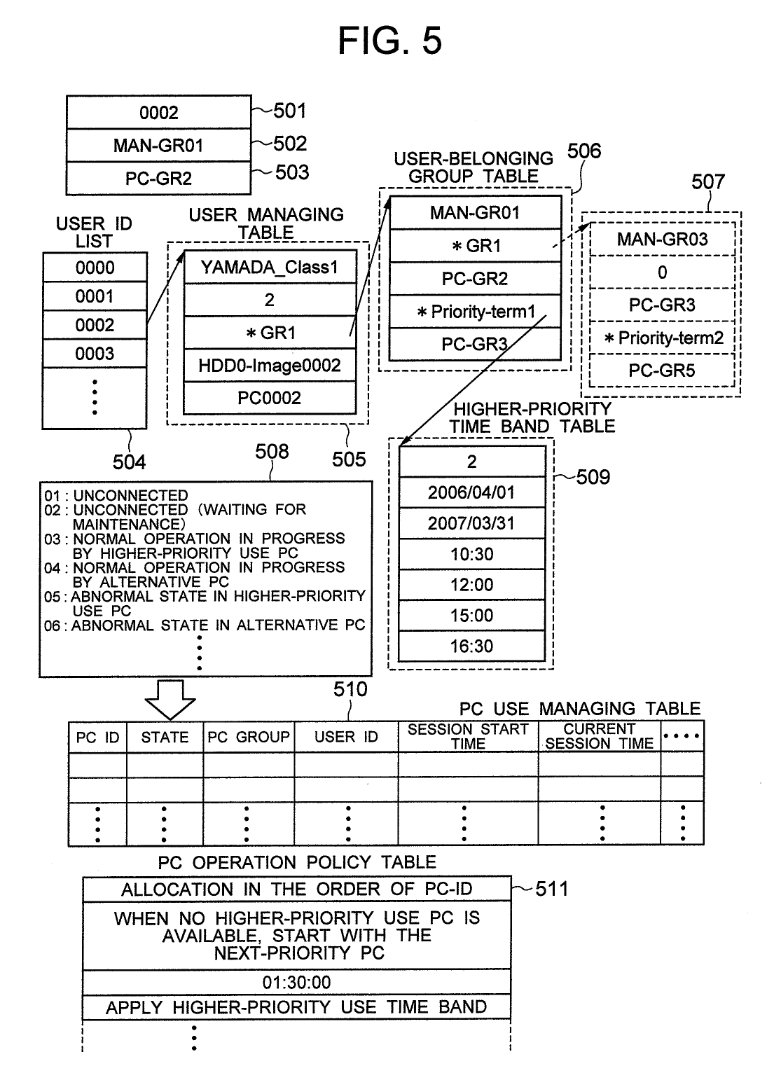

FIG. 4 is a flowchart showing an example of a flow of processes from a connection request made from the terminal device 105 by a user up to the connection of the usable personal computers 107, 109 from a viewpoint of the start server device 111. The flowchart will be explained by using FIG. 5 which corresponds to FIG. 3 and into which numerical values are actually written. The reference symbols 501 and after in FIG. 5 correspond to the reference symbols 301 and after in FIG. 3.

Firstly, in step 401, the start server device acquires data on the user ID 501, the user group ID 502, and the connection-requested PC group ID 503 shown in FIG. 5 from the terminal device of the user. In this example, the user ID is “0002”, the user group ID is “MAN-GR01”, and the connection-requested PC group ID is “PC-GR2”.

In the next step 402, the start server device uses the user ID list 504 shown in FIG. 5 to find the user managing table 505 of the user according to the user ID and then to find a first user-belonging group table 506 from the user group pointer. It should be noted that this table indicates that there is a user-belonging table other than this group for this user.

Subsequently, step 403 judges whether a belonging group exists. If the judgment result is Yes (Y), control is passed to step 404 and if No (N), control is returned to step 401. In this example, since other belonging group (user-belonging group table 507) is found as has been described above, control is passed to step 404.

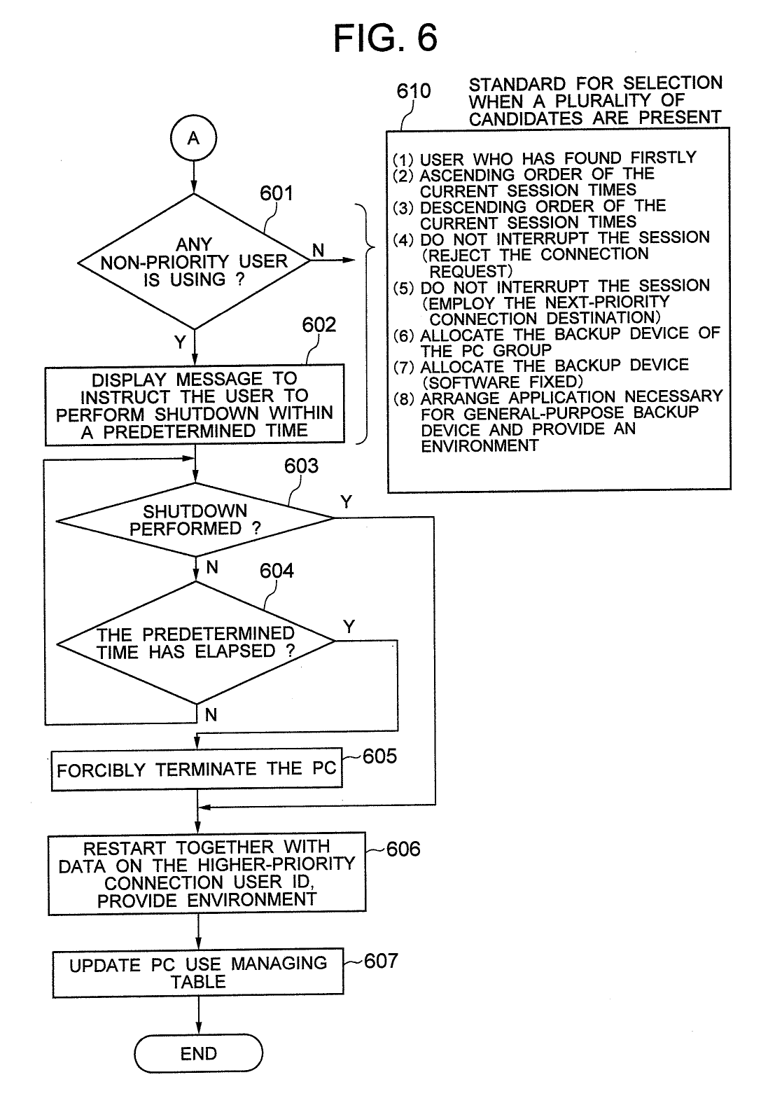

The step 404 checks whether any PC is available in the higher-priority connection PC group. If yes (Y), control is passed to step 405 and if no (N), control is passed to the process of FIG. 6 which will be detailed later.

When the higher-priority connection PC group has an available PC, step 405 selects “PC0002” which is ID of the available PC of the requested PC group “PC-GR2” according to the system PC operation policy table 511 and mounts a user data region to provide a use environment to the user. That is, “HDD0-Image0002” of the user managing table 505 is attached as a PC data region and connected to the terminal device which has made the request.

After this, step 406 stores “PC0002” as the current state in the region for storing the ID of the currently used ID and updates the PC group, the user ID, the session start time, and the current session time in the PC use managing table 510. The current session is recorded so as to make a comparison with the higher-priority time band table 509 to make a judgment and measure a total operation time for maintenance. The current session should be updated at a certain time interval.

Moreover, when the use is completed without any trouble, step 407 updates the data in the PC use managing table 510 and resets the currently used PC region in the user managing table 505. After this, in step 408, control is returned to a state for receiving a connection request from a new terminal device.

FIG. 6 explains an example of a process performed when no PC which can be used with a higher priority is available in the process of step 404.

When no PC of a higher priority is available, it is possible to provide an environment by deploying processes such as (1) the user who is found firstly, (2) the ascending order of the lengths of the current session time, (3) the descending order of the lengths of the current session time, (4) not interrupting the session (rejection of the connection request), (5) not interrupting the session (employing the connection destination of the next priority), (6) allocation of the backup device of the PC group, (7) allocation of the backup device (fixing software), and (8) application necessary for a general-purpose backup device.

The administrator defines the system operation in advance for the case when a selection standard 610 exists for selecting one of the candidates. The setting in advance in the portion having such a freedom is called the operation policy. It goes without saying that it is impossible to select an operation policy which cannot be satisfied by the system configuration. Hereinafter, explanation is given on the procedure to cause the non-priority user who is found firstly to terminate the personal computer used by him/her.

Firstly, when no one personal computer can be used with a higher priority, check is made to find whether any user is a non-priority user. Here, if all the users have a higher priority (N), separate processes (4) to (8) are performed according to the operation policy.

When a personal computer with a higher priority is found (Y), step 602 displays an instruction message to perform shutdown within a predetermined time on the personal computer of the user. For example, a message such as “perform shutdown within 5 minutes” is sent.

After this, step 603 checks whether the shutdown has been performed and step 604 checks whether the predetermined time has elapsed. If the predetermined time has elapsed (Y) without performing the shutdown (N), step 605 forcibly terminates the PC. Then, step 606 restarts the personal computer together with the data on the higher-priority connection user ID who has requested for the higher-priority connection so as to provide a use environment. After the environment is provided, step 607 updates the aforementioned management use table group.

The computer system according to the aforementioned embodiment includes the terminal device 105, the personal computers 107, 109, and the start server device 111 having the computer operation managing function and has advantages as follows.

(1) It is possible to reduce the recovery work by a user and an administrator who are forced to interrupt a job in spite of that no hardware has failed.

(2) When a system down of a personal computer has occurred, it is often recovered by re-installing an operating system and application software. Most of defects can be evaded by this. However, when start cannot be performed or the system is unstable even if it is started because of a hardware defect, the administrator should judge whether to replace the hardware. By providing log data for the judgment, the need of an active device check by the administrator may be suppressed.

(3) By registering a policy of preset about how to cause the system to behave when the start server device has failed in allocation or when a resource is actually insufficient, it is possible to semi-automate the operation and reduce TCO.

(4) By selecting a personal computer having a sufficient performance and a sufficient memory amount required for executing a job, it is possible to evade purchase of a device of a higher specification and a higher price than is required.

(5) It is possible to purchase a software license required and sufficient for executing a job, to perform a semi-automated inventory management, and to evade use of an authorized copy of software.

(6) By managing personal computers as a group, it is possible to limit the job server device which can be accessed by the group, thereby improving security.

(7) It is possible to suppress use of the application which has no use right from the beginning and reduce unnecessary inventories.

(8) Moreover, for example, when a school wants that computer resources not used be freely used by students and when the school has purchased clients and software only for the number of students who use them, there is a possibility that the students who take the lesson cannot use the necessary software/personal computers because other students are already using them. In order to solve this problem, by operating the personal computers which belong to a particular group with a higher priority use right, it is possible to interrupt/evade use of a user who uses a personal computer in which application having no use right is installed. This can contribute to lowering the operation cost by eliminating purchase of an unnecessary device or a software license depending on the setting.

The invention made by the present inventor and thus far explained according to the embodiment is not to be limited to the embodiment but may be modified in various ways without departing from the spirit of the invention.

The present invention may be applied to various jobs in government and other public offices, business firms, data centers, and other general transactions of business. Especially, the present invention enables optimal operation of the number of devices by performing an accurate inventory management in an organization having a plenty of client devices of various types, thereby reducing TCO. More development can be performed by monitoring a software process which is being operated in the background.

Moreover, when the time band priority function is enabled, for example, in a department which uses computers in a university, it is possible to effectively operate the computers with just enough computer resources. Furthermore, when no lesson is carried out in the department, the computers can be freely used by students, thereby enabling effective use of the computer resources.

It should be further understood by those skilled in the art that although the foregoing description has been made on embodiments of the invention, the invention is not limited thereto and various changes and modifications may be made without departing from the spirit of the invention and the scope of the appended claims.

1. A computer system comprising:
a terminal device in which a user performs direct operation or content check,
a plurality of personal computers connected to the terminal device via a network and serving as objects of remote operation by the user, and
a server device which selects a usable personal computer and connects it to the terminal device so as to provide a use environment to the user when the user has made an allocation request to any one of the personal computers via the terminal device.

2. The computer system as claimed in claim 1, further comprising:
a storage device for accumulating information created or referenced by the user in a system managed by the server device,
wherein when the user requests for an operation of a personal computer via the terminal device, the server device allocates information owned by the user or permitted to be read or modified, in the state in which read or modification is enabled, to the personal computer to provide a use environment to the user.

3. The computer system as claimed in claim 1,
wherein the server device selects a personal computer installed by a combination of a particular operating system and an application program type and a version according to information requested by the user via the terminal device, and provides a use environment to the user.

4. The computer system as claimed in claim 3,
wherein the server device selects a combination of a particular operating system type or a version and an application software type or a version according to information requested by the user and installs it in a personal computer after the selection so as to provide a use environment to the user.

5. The computer system as claimed in claim 4,
wherein the server device accumulates in advance the combination of the particular operating system type or the version and the application software type or the version as an image file of the storage device installed in advance in the storage device and spreads the image file on the personal computer upon reception of a use request so as to provide a use environment to the user.

6. The computer system as claimed in claim 1, comprising personal computers having different configurations in the system managed by the server device,
wherein the server device allocates a personal computer having the configuration appropriate to a job content of each user with a higher priority for a connection request made by the user via the terminal device.

7. The computer system as claimed in claim 6,
wherein the server device classifies the configuration characteristics of the personal computer as an attribute by combining one or more of (a) performance, (b) processor type, (c) type or version of the operating system provided, (d) combination of types or versions of the application programs provided, (e) position of the storage device connected or information in it, (f) usable capacity of the storage, (g) introduction time, (h) total operation time up to the introduction time, (i) arbitrary classification by an administrator, (j) backup device, (k) device for temporarily allocating use for a guest, (l) operation prepared or trial in progress, (m) memory size, (n) power consumption per unit time, and (o) network bandwidth size; and the server device allocates a personal computer having an appropriate attribute for the connection request made by the user via the terminal device with a higher priority.

8. The computer system as claimed in claim 7, wherein the server device classifies the personal computers into computer groups according to the attribute; allocates at least one of the following items to all the computers: (a) an identifier as a single article of each personal computer, (b) an identifier of the computer group to which a personal computer belongs (including the case when a personal computer belongs to a plurality of computer groups), (c) a current status of a personal computer is “in use”, “not used”, “waiting for maintenance”, “not set”, “allocated as a personal computer not appropriate for a connection request”; holds information on a correspondence table between the identifier as a single article and the identifier as the computer group, a region for storing the status, and an identifier of the user if in use, while updating the information to the latest state; and selects and allocates a personal computer which is optimal for a new connection request according to these information.

9. The computer system as claimed in claim 8,
wherein the server device assigns as the user attribute at least one of the following items to all users: (a) a unique name or an identifier for each user, (b) a user group identifier of a department or a school lesson class to which the user belongs (including the case when a user belongs to a plurality of groups), (c) a computer group identifier of the personal computer which the user can use with a higher priority (including the case when a change occurs depending on the use period of time and use time band), (d) a priority use level (including the case when a plurality of levels are present), (e) a computer group identifier of a personal computer which can be used with a higher priority according to the priority level (including the case when a plurality of identifiers constitute a pair with the priority use level), (f) time band or period of time of the computer group identifier of the personal computer which can be used according to the priority level (including the case when a plurality of time bands or periods of time constitute a pair with the priority use level and the case when a change occurs depending on the day of the week or the date), (g) use of the model having no priority use is enabled/disabled, (h) a computer group identifier of the model of the non-priority use, (i) a status region for storing a dynamic state during a use of a personal computer, i.e., whether an identifier of a personal computer and an identifier of a computer group to which the personal computer belongs, and the personal computer in use are connected with a higher priority of the user; holds them in a local storage device, and references the attribute of the user, the priority level, and the status of the personal computer upon reception of a request for use of the personal computer made by a user via a terminal device so as to select and start a most appropriate personal computer so that the information owned by the user and the server device group required for the job and connected by the network can be operated from the terminal device; and updates the stored values to values appropriate for the current state each time the status of all the personal computers and the state of the status regions of all the users change.

10. The computer system as claimed in claim 9, wherein when a user makes a request for using a personal computer via the terminal device and if all the personal computers matched with the user attribute are in use or no appropriate personal computer exists because of failure or maintenance, at least one of the following processes is executed: (a) an unused personal computer of other computer group having a lower priority for the user is presented to the user so that the user can decide whether to use the unused personal computer, (b) one of the current users who are using the personal computer of a not optimal computer group is terminated with a predetermined rule and it is allocated to the user, (c) no connection is made until the computer group which can be used with a higher priority by the user group of the user who has made the connection request can provide an empty space, (d) a personal computer for a guest or a backup device is allocated.

11. The computer system as claimed in claim 10, wherein the server device decides the predetermined rule by a combination of at least one of the following: (a) the current sessions are disconnected in the descending order of the lengths, (b) the current sessions are disconnected in the ascending order of the lengths, (c) disconnection is performed in the arrangement order of user ID in use in the state that no optimal allocation is performed (both in the ascending order and in the descending order), (d) disconnection is performed in the arrangement order of the personal computer IDs which are not allocated optimally (both in the ascending order and the descending order), (e) disconnection is performed in the descending order of the network load of the personal computers in use, (f) disconnection is performed in the ascending order of the network load of the personal computers in use, (g) disconnection is performed in the descending order of the power consumption of the personal computers in use, (h) disconnection is performed in the ascending order of the specified power of the personal computers in use.
